(19) United States
(12) Patent Application Publication
(10) Pub. No.: US 2007/0291016 A1
(43) Pub. Date: Dec. 20, 2007

(54) Capacitive Position Sensor

(76) Inventor: Harald Philipp, Drogheda (IE)

Correspondence Address: DAVID KIEWIT, 5901 THIRD ST SOUTH, ST PETERSBURG, FL, 33705, US

(21) Appl. No.: 11/765,393

(22) Filed: Jun. 19, 2007

Related U.S. Application Data
(60) Provisional application No. 60/805,249, filed on Jun. 20, 2006.

(51) Int. Cl. G06F 3/045

(52) U.S. Cl. 345/174

(57) ABSTRACT

A capacitive position sensor comprising a preferably annular sensing path, the sensing path having one or more virtual buttons designated along its length. The sensing path has a plurality of terminals connected to it to subdivide it into a plurality of sections, each terminal providing a sensing channel for a signal indicative of capacitance. The sensing channels provide the signals to a processor, preferably a microcontroller, that is operable to distinguish between a user making a touch to actuate one of the virtual buttons, and a touch to perform a scrolling function. To be determined as a scroll, it is required that there is a succession of detects which span over at least a threshold distance, for example an angular or linear distance. To be determined as a touch, it is required that there is a succession of detects that all lie within one of the pre-assigned virtual button positions.

### BACKGROUND OF THE INVENTION

The invention relates to capacitive position sensors, more particularly the invention relates to capacitive position sensors for detecting the position of an object around a curved path.

Capacitive position sensors are applicable to human interfaces as well as material displacement sensing in conjunction with controls and appliances, mechanisms and machinery, and computing.

Capacitive position sensors in general have recently become increasingly common and accepted in human interfaces and for machine control. In the field of home appliances for example, it is now quite common to find capacitive touch controls operable through glass or plastic panels. These sensors are increasingly typified by U.S. Pat. No. 6,452,514 which describes a matrix sensor approach employing charge-transfer principles.

Due to increasing market demand for capacitive touch controls, there is an increased need for lower cost-per-function as well as greater flexibility in usage and configuration. Similarly, there is a significant demand for capacitive material displacement sensors (e.g. fluid level sensors, mechanical movement sensors, pressure sensors etc.) at lower price points, which cannot be easily met with current generations of non-mechanical transducers. In many applications there is a need for a human interface having many keys or sensing positions, nearly (but not) akin to the flexibility afforded by 2-D touch screens or touch pads.

Recently there has been the appearance of ‘scroll wheels’ as input devices, as typified by the Apple Computer ipod MP3 player (see U.S. Pat. No. D472,245). These devices have either a mechanical input scroll device or a capacitive device. There exists a substantial demand for new human interface technologies which can, at the right price, overcome the technical deficits of electromechanical controls on the one hand, and the cost of touch screens or other exotica on the other.

The applicant's earlier international patent application WO2005/019766A2 describes a capacitive position sensor for detecting the position of an object, typically an operator's finger, relative to a resistive sensing element, wherein the sensing element comprises a sensing path that has terminals connected along it that subdivide the sensing path into multiple sections. Each terminal is coupled to its own sensing channel, each of which generates a signal that is sensitive to the capacitance between its terminal and a system ground. The signals are fed to a processor for analysis. The processor determines over which section the object is positioned by comparing the signals from the sensing channels, and determines the position of the object within that section by comparing the signals from the terminals spanning that section. In this way, the sensing path can be formed in a closed loop, such as a circle for a scroll dial, in which the operator's finger position and movement can be determined in a straightforward manner.

Other wheel detectors are described in GB2050621A, U.S. Pat. No. 4,158,216, WO03/088176A1. A linear detector is described in U.S. Pat. No. 5,977,956.

### SUMMARY OF THE INVENTION

The applicant has now developed improvements over the capacitive position scroll sensor described in WO2005/019766A2. According to the disclosure of WO 2005/019766A2, there is described a capacitive position sensor for detecting a position of an object comprising:
(a) a sensing element comprising a sensing path;
(b) a plurality of at least three terminals connected to the sensing element at different locations along the sensing path to subdivide it into a plurality of sections;
(c) a plurality of sensing channels connected to respective ones of the terminals, wherein each sensing channel is operable to generate a signal indicative of capacitance between its terminal and a system ground; and
(d) a processor operable to determine over which section the object is positioned by comparing the signals from the sensing channels, and to determine the position of the object within that section by comparing at least the signals from the terminals spanning that section.

In the present invention, there is provided an improved capacitive position sensor capable of detecting capacitive coupling with an object in which the capacitive coupling may be caused by moving displacement of the object along the sensing element of the sensor or by capacitive coupling of the object in at least one predetermined absolute position on the sensing element. The capacitive position sensor of the invention is capable of distinguishing between touch from an absolute position and touch from a moving displacement on a sensing element.

According to an aspect of the invention, there is provided a capacitive position sensor for detecting a position of an object comprising:
(a) a sensing element comprising a sensing path and a plurality of sensing areas spaced along the sensing element;
(b) a plurality of at least three terminals connected to the sensing element at different locations along the sensing path to subdivide it into a plurality of sections;
(c) a plurality of sensing channels connected to respective ones of the terminals, wherein each sensing channel is operable to generate a signal indicative of capacitance between its terminal and a system ground; and
(d) a processor operable to determine (i) over which section the object is positioned by comparing the signals from the sensing channels, and to determine the position of the object within that section by comparing at least the signals from the terminals spanning that section or (ii) over which sensing area the object is positioned.

The capacitive position sensor of the invention is able to distinguish between touch in an absolute position and touch caused by a moving displacement by means of key parameters, based on duration of touch and distance of displacement, which may be programmed in the form of an algorithm into a processor.

To be determined as a scroll, it is required that there is a succession of detects which span over at least a threshold distance, for example an angular distance in an annular sensor, or a linear distance in a linear sensor. To be determined as a touch, it is required that there is a succession of detects that lie within one of the pre-assigned virtual button positions, i.e. the detects all lie within a certain range of reported positions that define the virtual button.

In an embodiment of the invention, the sensing element comprises a plurality of discrete sensing areas located in a spaced relationship along the element. It is preferred that there are four discrete sensing areas, although there could be more dependent on the application of the position sensor. If an object is capacitively coupled to any one of the discrete areas, the sensing channel may detect the signal. The position sensor of the invention may be used in different applications where it is important to be able to detect touch in a discrete sensing area and touch along a sensing path caused by moving displacement, e.g. in a mobile phone. Capacitive coupling of a user's finger to at least one of the discrete sensing areas may be used to select a desired function on a mobile phone. A processor may be programmed such that a tap or touch on one of the discrete sensing areas for a minimum duration of time is sufficient to cause capacitive coupling and generate a signal to select a pre-determined function. Between each discrete sensing area, there may be ‘dead’ regions such that no output signal is produced in these regions.

The position sensor of the invention is advantageously able to discriminate between touch in an absolute position and touch caused by movement on the sensing element. The sensor may be programmed to detect a minimum threshold of movement caused by an object on the sensing element and if the minimum threshold is reached, the sensor may recognise that capacitive coupling caused by displacement of the object along the sensing element is to be detected. In a preferred embodiment of the invention, the sensing element is arcuate in shape. It is particularly preferred that the sensing element is in the form of a closed loop for use in a rotary capacitive position sensor.

In a particularly preferred embodiment, the capacitive position sensor may be arranged such that a minimum threshold value is selectable and this threshold value needs to be reached in order for the capacitive sensor to start producing a signal indicating a touch caused by movement of an object on the sensing element. If the sensing element is in the form of a closed loop, the rotary capacitive position sensor may be arranged to have a threshold angle value selected from a range. The range may be from 5 degrees to 360 degrees, although a more suitable range would be from 20 degrees to 180 degrees. In a preferred embodiment, the threshold angle value is selected from between 40 degrees and 50 degrees, 45 degrees being preferred. If the capacitive position sensor of the invention is set to have a threshold angle value of 45 degrees, the sensor will detect a moving touch on the sensing element below the 45 degrees angle, and when the threshold value is reached the sensing element may be ‘unlocked’ so as to generate a signal indicative of capacitive coupling with an object. The magnitude of the output signal may be based on the distance of displacement of the object on the sensing element. For example, in the rotary capacitive position sensor embodiment, an object may be moved along the sensing element of the sensor for at least one revolution, and for a plurality of revolutions, and the distance moved by the object may determine the output signal which is processed by the sensing channels. This aspect of the invention is particularly beneficial for use in a mobile phone device or an MP3 player where it is often required to scroll up and down lists of information relating to, for example contact names, telephone numbers and songs.

When the position sensor of the invention reaches an ‘unlocked’ condition, that is when the threshold angle value has been reached by displacement of a user's finger on the sensing element by a given distance, the sensing element becomes freely scrollable allowing a user to scroll ‘up’ or ‘down’ lists of data by moving their finger clockwise or anti-clockwise along the sensing element. Capacitive coupling is sensed during displacement of the user's finger along the sensing element and the output signal may be produced when the user's finger is removed from the sensing element based on an item of desired data that has been found. Before the threshold angle value is reached, capacitive coupling of an object to the sensing element may be detected, but no output signal may be produced in one or more sensing channels, until the signal has passed the threshold angle value. If a user's finger stops scrolling for a pre-determined period of time, then the scrolling action may need to be commenced again.

The threshold angle value can preferably be reset, by an algorithm programmed into a processor. By resetting the threshold value of the capacitive sensor of the invention, the displacement required to produce a signal output may be varied.

In an embodiment of the invention, the capacitive position sensor may further comprise one or more discrete sensing areas in the center region of a rotary sensing element. Preferably, if the sensing areas in the center region of the sensing element sense capacitive coupling to an object, any signal produced from the sensing element is reduced or ‘locked out’ using the Adjacent Key Suppression™ technology described in the applicant's earlier U.S. Pat. No. 6,993, 607 and U.S. Ser. No. 11/279,402. Any output signal from the sensing element caused by capacitive coupling may also lock-out a signal from the central sensing areas.

The resistive sensing element may be embodied by a single resistor, for example it may comprise a resistive material deposited on a substrate to form a continuous pattern. This provides for an easy-to-fabricate resistive sensing element which can be deposited on the substrate in any one of a range of patterns. Alternatively, the resistive sensing element may be made from a plurality of discrete resistors. The discrete resistors may be alternately connected in series with a plurality of conducting sense plates, the sense plates providing for increased capacitive coupling between the object and the resistive sensing element. This provides for a resistive sensing element which can be fabricated from widely available off-the-shelf items.

The discrete sensing areas may comprise a resistive material and may form part of the sensing element.

The resistive sensing element may have a substantially constant resistance per unit length. This provides for a capacitive position sensor having a simple uniform response.

Where greater positional resolution is required and/or when employing a relatively long resistive sensing element, the resistive sensing element may include more than three terminals.

The sensing channels may each include a sampling capacitor connected in series with a corresponding one of the capacitances between the terminals and the system ground such that when connected to a supply voltage each of the sampling capacitors are supplied with an amount of charge which depends on the capacitance between the corresponding ones of the terminals and the system ground. This effectively provides each sensing channel with a capacitive voltage divider comprising the capacitance of the sampling capacitor and the effective capacitance to ground caused by the object's capacitive coupling to the resistive sensing element. This allows the capacitances between each of the terminals and the system ground to be determined from the voltage measured on corresponding ones of the sampling capacitors.

Charge transfer techniques may be used, for example whereby each of the sensing channels comprises a plurality of switching elements and the capacitive position sensor includes a switch controller configured to allow a switching sequence of the switching elements to be performed such that the switching sequence causes each of the sampling capacitors to be connected to and then disconnected from the supply voltage and the terminals to be subsequently connected to the system ground. This provides for a simple way to transfer an amount of charge to each of the sampling capacitors which depends on the capacitances between each of the corresponding terminals and the system ground.

The switching sequence may be executed multiple times, with the terminals being disconnected from the system ground before each sequence execution, such that the sampling capacitors are incrementally charged during each sequence execution. This may be done a variable number of times, whereby the number of sequence executions required to charge each of the sampling capacitors to a pre-determined level provides the signals indicative of capacitances between each of the terminals and a system ground, or a fixed number of times, whereby the charge on each of the sampling capacitors after a fixed number of sequence executions provides the signals indicative of capacitances between each of the terminals and a system ground.

If there is a significant level of background capacitive coupling between each of the terminals and the system ground (i.e. not due to the presence of the object), the processor may be configured to subtract respective background signals from each of the signals prior to the comparing step. The background signals may correspond to the signals obtained when an object whose position is to be detected is distal from the capacitive position sensor. This means that effects due to the position of the object on the capacitances between the terminals and the system ground can be isolated from those found when the object is not present. The background signals may be calculated regularly during use to account for changing conditions.

To determine whether an object is present and to avoid confusion which may occur in attempting to generate a parameter indicative of a position of an object when none is present, the processor may be configured to sum the respective signals from the sensing channels and to generate a parameter indicative of a position of an object only if the magnitude of the sum exceeds a detection threshold. The threshold can be set according to how sensitive a designer wishes the capacitive position sensor to be. For example, where there are a number of closely spaced capacitive position sensors on a control panel, the designer may require a high detection threshold to prevent perceived positive detections in one capacitive position sensor when a neighbouring capacitive position sensor is being touched. In another case, a lower detection threshold may be preferred to increase the sensitivity of the capacitive position sensor. The processor may be configured to output a status signal indicative of whether the magnitude of the sum of the signals exceeds the detection threshold. This may assist appropriate responses by connected apparatus, e.g. functional equipment being controlled by a control panel.

Once a first parameter indicative of the position of an object has been generated, the capacitive position sensor may then generate a second parameter indicative of the position of the object at a later time and output a signal indicative of motion of the object between the first and second times.

The object to be detected may be a pointer, for example a finger or a stylus, which can be freely positioned by a user. Alternatively, the object may be a wiper held in proximity to the resistive sensing element, the position of the wiper along the resistive sensing element being detected by the capacitive position sensor. The position of the wiper may be adjusted by a user, for example by turning a rotary knob, or may be coupled to a shaft driven by connected equipment such that the capacitive position sensor can act as an encoder.

In a further embodiment of the invention, the circular element comprises a plurality of discrete resistors electrically connected in series, wherein electrode connections are made in 3 places, and where the junctions of resistor pairs are connected to discrete conductive electrodes to form individual sensing locations. A minimally useful sensor would have 6 resistors along the circle and therefore 6 sensing areas.

Another object is to provide for a ‘finger scroll wheel’ effect through a plastic surface.

Further objects of some embodiments of the invention are to provide for a sensor having high reliability, a sealed surface, low power consumption, simple design, ease of fabrication, and the ability to operate using off-the-shelf logic or microcontrollers.

In U.S. Pat. No. 6,466,036, the applicant teaches a capacitive field sensor employing a single coupling plate to detect change in capacitance to ground. This apparatus comprises a circuit employing repetitive charge-then-transfer or charge-plus-transfer cycles using common integrated CMOS push-pull driver circuitry. This technology forms the basis of some embodiments of the invention and is incorporated by reference herein.

One embodiment of the invention includes a sensing element, a plurality of discrete sensing areas within the sensing element and a control circuit designed to provide a circular surface from which can be read the location of a finger capacitively coupled to the sensing element or one of the discrete sensing areas, wherein the control circuit has three sensing channels for measuring capacitance simultaneously at three electrode points along the circle and a computing device, such as a processor comprising processing logic circuitry, computes the ratio of the relative changes in the amount of capacitance measured at the three points. The result of this computation is a 1-dimensional angular co-ordinate number plus a detection state indicator, both of which can be fed to another function, for example an appliance controller, which interprets the co-ordinate and detection state as a command or measurement. The disclosure of WO2005/019766A2 is incorporated herein by reference.

In an embodiment of the invention, the sensing element is a circular element with three distinct electrodes thereon. Connections are made between each electrode and a circuit comprised of capacitive signal acquisition and signal processing means. The element is normally disposed on an insulating substrate, and is large enough to accommodate the desired targets for detection purposes. The sense field propagates through the substrate; the other side of the substrate forming the active sensing surface for human touch or a mechanical wiper. Direct touch on the element is also possible in which case the substrate only acts as a mechanical carrier. While it is supposed that an element could be solid enough that no substrate is required, normally the element will be a thin layer requiring mechanical support.

Some definitions are now made. The terms ‘connection(s)’ or ‘connected’ refer to either galvanic contact or capacitive coupling. ‘Element’ refers to the physical electrical sensing element made of conductive substances. ‘Electrode’ refers to one of the galvanic connection points made to the element to connect it to suitable driver/sensor electronics. The terms ‘object’ and ‘finger’ are used synonymously in reference to either an inanimate object such as a wiper or pointer or stylus, or alternatively a human finger or other appendage, any of whose presence adjacent the element will create a localized capacitive coupling from a region of the element back to a circuit reference via any circuitous path, whether galvanically or non-galvanically. The term ‘touch’ includes either physical contact between an object and the element, or, proximity in free space between object and element, or physical contact between object and a dielectric (such as glass) existing between object and element, or, proximity in free space including an intervening layer of dielectric existing between object and element. Hereinafter the terms ‘circle’ or ‘circular’ refer to any ellipsoid, trapezoid, or other closed loop of arbitrary size and outline shape having an open middle section. The mention of specific circuit parameters, or orientation is not to be taken as limiting to the invention, as a wide range of parameters is possible using no or slight changes to the circuitry or algorithms; specific parameters and orientation are mentioned only for explanatory purposes.

### BRIEF DESCRIPTION OF THE DRAWINGS

FIG. 1 illustrates an embodiment of the invention showing a mobile phone;

FIG. 2 schematically shows a section view of the conductive sensing element of FIG. 1 bonded to one side of a dielectric surface;

FIG. 3 shows the electrode pattern of the sensing element of FIG. 2 together with the wiring of the control circuit implemented as a microcontroller;

FIG. 4A shows ideal channel response signals from the wheel electrodes FIG. 3;

FIG. 4B shows real channel response signals from the wheel electrodes FIG. 3; and

FIG. 5 is a flow diagram of an example processing algorithm for the sensor of FIG. 3.

### DETAILED DESCRIPTION OF A PREFERRED EMBODIMENT

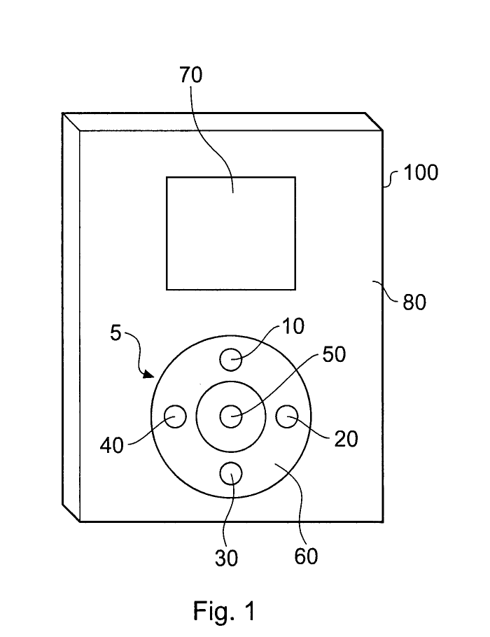

FIG. 1 illustrates an embodiment of the invention showing a mobile phone.

Referring to FIG. 1, there is illustrated an embodiment of the invention showing a mobile phone 100 having a multi-function sensor 5 comprising an annular sensing element 60 forming a so-called wheel, discrete sensing buttons 10, 20, 30, 40 formed within the area of the sensing element 60, and a central sensing button 50. A display 70 is also shown located above the sensor area. The display 70 and multi-function sensor 5 are formed in a front panel 80 of the device which may be made of a suitable plastics material or another material of choice such as glass, a ceramic material, a composite material, or a natural material such as wood or a wood veneer. It may also be painted.

It will be appreciated that in other embodiments the device could be a music player, radio, games console, remote controller or a device combining multiple ones of the above-mentioned functions of phone, music player, video player, stills photography storage and/or display device, radio, games console, in-flight multimedia controller, remote controller and so forth.

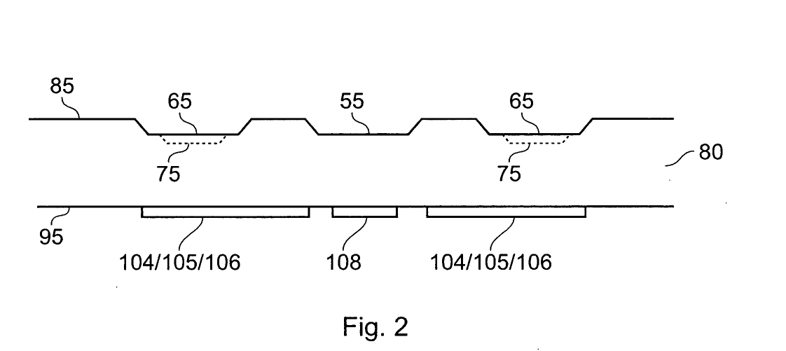

FIG. 2 schematically shows a section view of the region that accommodates the multi-function sensor 5. The multi-function sensor 5 is formed in a region of the front panel 80, the front panel 80 forming a substrate for the multi-function sensor 5. The substrate has an upper surface 85, i.e. the external surface of the device, which has an annular recess 65 formed therein as part of the annular sensing element 60, as well as a circular recess 55 arranged in the center of the annular recess 65 as part of the central sensing button 50. The recesses 55 and 85 are dimensioned to allow tactile location of a human finger. The recesses 55 and 85 are formed by milling, moulding or other suitable process. Four further circular recesses 75 are formed in the base of the annular recess 65 as part of the discrete sensing buttons 10, 20, 30, 40. These further recesses 75 are relatively shallow so that a finger can scroll round the annular recess without undue hindrance, but nevertheless allow a user to feel their presence. As an alternative to further recesses 75, a protrusion could be used to allow user location of buttons 10, 20, 30 and 40, or other tactile feedback, such as a change in surface roughness over the button area.

The front panel also has a lower surface 95 on which are located conductive sensing electrodes 104, 105, 106 and 108. Electrode 108 is located under central circular recess 55 for the center button 50. Electrodes 104, 105 and 106 are arranged outside the electrode 108 and collectively have an annular shape. A radially outer portion of the electrodes 104, 105 and 106 is arranged under the annular recess 65 (and radial button recesses 75).

The conductive electrodes are mounted on the lower surface 95. This may be by direct bonding, e.g. through evaporation, or by bonding or fastening a sheet of supporting material (not shown), e.g. a thin film of flexible dielectric plastics material, to one side of a dielectric surface, wherein the electrodes are formed on the supporting material.

The conductive electrodes may be formed in a variety of ways, for example using PCB, FPCB, silver or carbon on film, ITO (indium tin oxide) on film, or Orgacon™ ink on film. The thickness of the panel 80 may be varied according to the material used and electrode size by adjusting the threshold level chosen for the sensors. Typically, the panel will have a thickness between 1 mm and 10 mm, more usually between 2 mm and 6 mm. For glass, the maximum possible thickness is usually about 10 mm, for plastics material about 5 mm.

The button areas 10, 20, 30, 40 may additionally have a pressure sensing element arranged under the electrodes 104, 105 and 106. The pressure sensing element comprises a pressure sensing transducer which may have either a discrete or analog output and which may be made from, without limitation, any compressible material in any shape which can respond in a predictable way to an applied pressure.

The button areas 10, 20, 30 and 40 may additionally have a haptic element arranged under the electrodes 104, 105 and 106 to provide acoustic or motion response under the control of either the processor or independent control from the device. The haptic element may comprise without limitation a solenoid, speaker, piezo element, motor, or other moving mass transducer responsive to an applied power source. Both a pressure sensing element and a haptic element may be provided in combination.

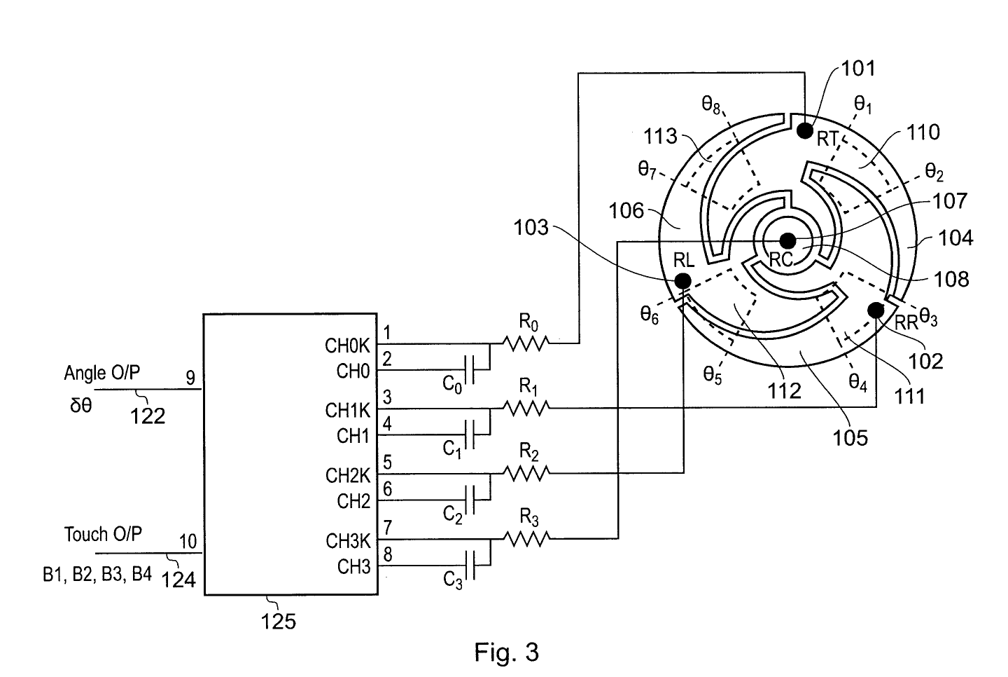

FIG. 3 shows in its upper right portion the electrode pattern of the conductive electrodes 104, 105, 106 and 108 together with the wiring of the control circuit, which is principally implemented with a processor chip 125 which may be a single logic device such as a microcontroller. The microcontroller may preferably have a push-pull type CMOS pin structure, and an input which can be made to act as a voltage comparator. Most common microcontroller I/O ports are capable of this, as they have a relatively fixed input threshold voltage as well as nearly ideal MOSFET switches. The necessary functions may be provided by a single general purpose programmable microprocessor, microcontroller or other integrated chip, for example a field programmable gate array (FPGA) or application specific integrated chip (ASIC).

The center electrode 108 has a circular shape as illustrated. Each of the three electrodes 104, 105 and 106 for the annular sensing element 60 is of identical shape, the electrodes being angularly offset from each other by 120 degrees to form a complete annular pattern. Each electrode extends over two-thirds of the angular extent of the sensing element 60, i.e. over 240 degrees. Over a radially outer portion of their collective extent, which approximately coincides with the annular recess 65, at any particular angle two of the three electrodes are in a tapered relationship with the other electrode not being present. The angular position of a finger touch at a given location in the annular recess can thus be determined from the absence of signal from one electrode and the ratio of the signals from the other two electrodes.

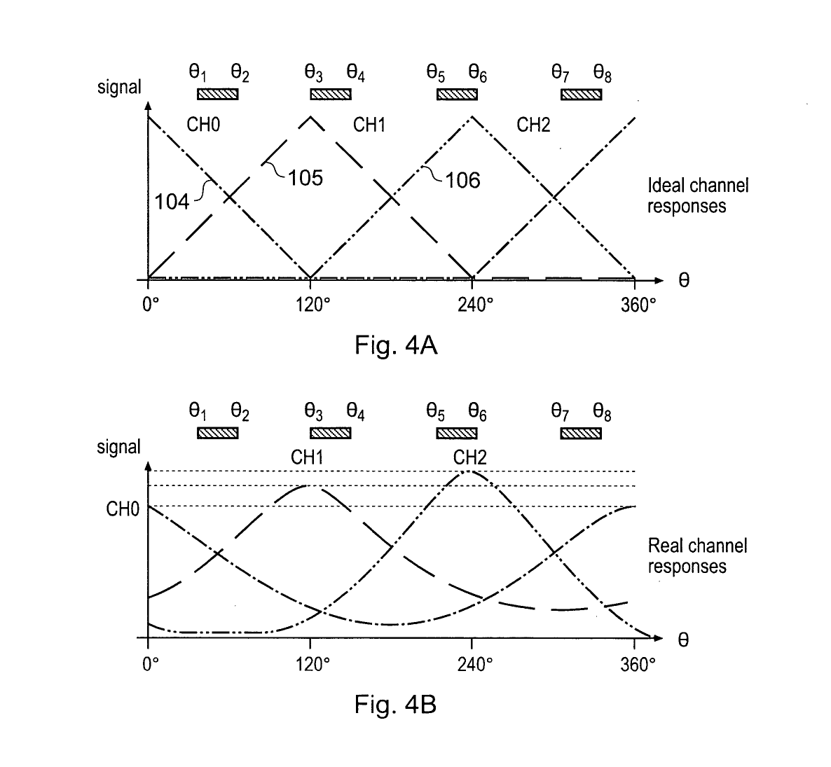

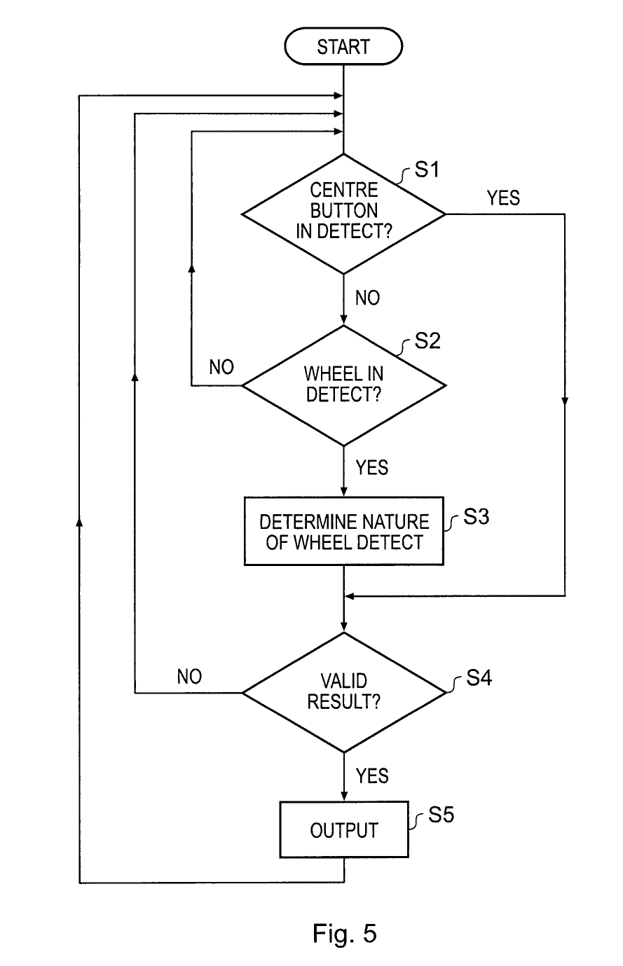

Other geometric forms of conductive electrodes can be used to provide the same effect. Further details of these kinds of arrangement are given in my earlier US patent U.S. Pat. No. 6,288,707 (see for example FIGS. 4, 5 & 6 and supporting text) and also my earlier WO2005/019766A2 (see FIG. 15 and supporting text). What is important is that the mutually co-extending pairs of electrodes provide a graduation in sensitive area with angle.

The electrodes 104, 105, 106 and 108 have respective terminals 101, 102, 103 and 107 where respective connection lines are electrically connected for respective sensing channels CH0, CH1, CH2 and CH3 as illustrated.

The connection lines for the sensing channels CH0, CH1, CH2 and CH3 lead through respective resistors R0, R1, R2 and R3 and then split into two with one connection of each pair being directly connected to one pin of the microcontroller chip 125 and the other connection connected via a respective capacitor C0, C1, C2 and C3, which are the sense capacitors for charge collection and accumulation during bursts.

The other pins illustrated connect to two output lines 122 and 124. Output line 122 is for outputting angle values representing angles of motion δΘ around the wheel, i.e. the annular sensor. Output line 124 is for outputting touch signals, which may originate from the center touch button 50 or any of the buttons 10, 20, 30, 40 that are located on the annular sensing element. The outputs can be either a pulse width modulated (PWM) signal which can be filtered to analog form, or a serial output such as the well known UART, SPI, or 12C formats (or any other type).

Further pins of the microcontroller 125 are not illustrated, such as pins for ground and positive power, reset, clock, address select and so forth, since these have no direct bearing on the invention and will be readily understood by a person skilled in the art.

Returning to the multi-function sensor 5, the figure shows with dashed lines four angular segments along the annular sensing path, which are spaced 90 degrees to each other and each span an angle of 30 degrees. Namely, a first segment 110 extends from angle Θ1 to Θ2, a second segment 111 extends from angle Θ3 to Θ4, a third segment 112 extends from angle Θ5 to Θ6 and a fourth segment 113 extends from angle Θ7 to Θ8. These four segments show sensing areas for four virtual buttons in the annular sensing path, and correspond to buttons 10 to 40 of FIG. 1, the only difference being that they are illustrated in FIG. 3 rotated by 45 degrees compared with the illustration of FIG. 1.

The buttons 10 to 40 are referred to as virtual buttons, since they have no dedicated electrodes, but rather are identified by processing of the signals from the electrodes 104, 105 and 106.

Operation of the circuit is now described. The signals from the three annular electrodes are collectively processed in the processor 125 to determine a touch angle on the annular sensing path.

The full angular range of 360 degrees is divided into a maximum of 255 in one example implementation which uses a single byte register for the angle and thus provides an angular increment of roughly 1.4 degrees. Coarser angular resolutions can be set by suitable programming of the microcontroller. Typically, for a finger actuated wheel, the angular resolution will be set so that each angular increment is somewhere between about 10 to 20 degrees and 40 to 50 degrees. Angular increments that approach 180 degrees or greater values should not be used, since it becomes impossible to detect scroll direction, i.e. to differentiate between clockwise from anticlockwise motion.

FIG. 4A is now used to describe the algorithm embodied in the switching logic to compute wheel angle. The figure is a graph showing ideal channel response signals from the wheel electrodes 104, 105 and 106 as a function of angle, where zero angle is taken to be at the 12 o'clock or North position. The signal from electrode 104 is shown by the dot-dash line, from electrode 105 by the dash line and from electrode 106 by the dot-dot-dash line. As illustrated, in the angular range 0 to 120 degrees there is no signal from electrode 106, since it has no angular extent over this range, and the signal is a linearly varying ratiometric one from electrodes 104 and 105, being dominated by electrode 104 at 0 degrees and by electrode 105 at 120 degrees, the two electrodes 104 and 105 providing equal signal strengths at 60 degrees. Further, in the angular range 120 to 240 degrees there is no signal from electrode 104, and the signal is a ratiometric one from electrodes 105 and 106, being dominated by electrode 105 at 120 degrees and by electrode 106 at 240 degrees, the two electrodes 105 and 106 providing equal signal strengths at 180 degrees. Finally, in the angular range 240 to 360 degrees there is no signal from electrode 105, and the signal is a ratiometric one from electrodes 106 and 104, being dominated by electrode 106 at 240 degrees and by electrode 104 at 0 degrees, the two electrodes 106 and 104 providing equal signal strengths at 300 degrees. For reference, the angular ranges of the angular segments associated with the virtual buttons are also illustrated in the graph.

FIG. 4B is similar to FIG. 4A, but illustrates schematically what might be expected in reality for the channel response signals from the wheel electrodes. It will be seen the peaks from the three electrodes do not have the same signal magnitude, and also that each electrode signal has different zero offsets. The progression of the pairs of ratiometric signals is also not precisely linear. These deviations from the ideal can be accounted for at least partially through suitable signal processing.

The touch angle derived from the signals from electrodes 104, 105 and 106 is calculated as follows.

First, each of the signals S0, S1 and S2 from channels CH0, CH1 and CH2 respectively is scaled in proportion to the channel's burst length found at calibration to provide normalised signals S0′, S1′ and S2′. Burst length is the number of cycles of charge accumulation in the sense capacitor required to reach a threshold voltage set by a comparator. This improves linearity.

Second, the smallest of the normalised signals S0′, S1′ and S2′ is identified. This is subtracted from the other two signals to provide signals A and B. The smallest signal also identifies which of the three main angular segments of the wheel the touch is located, for example if S1′ is the smallest signal, then the touch is between 240 and 360 degrees.

Third, the angle is computed as [120*A/(A−B)]+s*120, where s is the segment or channel number, i.e., 0, 1 or 2 in this example.

The processor is thus operable to determine the position of the object within the determined section by a ratiometric analysis of signals taken from the terminals spanning the determined section.

It will be appreciated that this is a relatively high level description. For a lower level detailed description showing how the charge is accumulated and transferred to signal inputs for the microcontroller, we refer to WO2005/019766A2, specifically the detailed description of FIGS. 5 to 8 and 10 thereof which is incorporated herein by reference. Further details may be found in U.S. Pat. No. 7,148,704 which is incorporated herein by reference.

In addition, the microcontroller 125 will determine a signal S3 from CH3. This is from the single dedicated touch electrode 108. The acquisition of signal S3 is conventional single button acquisition as described in the prior art, such as my U.S. Pat. No. 6,466,036.

Having now described how an angle value is obtained, the higher level signal processing is now described.

FIG. 5 is a flow diagram of an example processing algorithm for the multi-function sensor.

In Step S1, the processor determines whether the center button (CH3) is “in detect”. At its simplest, “in detect” means that the signal is above threshold for a single detect cycle. However, preferably a detect integrator is used, whereby a detect is only reported if more than a set number of successive detects has been reported. As soon as one detect falls below threshold, the integration is aborted and restarts from zero. The number of successive detects required is programmable in the microcontroller, and may be set between 1 and 256 (i.e. one byte register). Typical values are between 3 and 5. If CH3 is in detect, a valid result flag is set and the flow moved to Step S4 which is passed in view of the valid result flag being set and a touch signal is output in Step S5 on line 124 (pin 10 of the microcontroller). If CH3 is not in detect, then the process flow moves to Step S2 and it is tested whether the wheel is in detect. Once again detect integration is preferably used to provide noise immunity. If the wheel is not in detect, then the process loops back to prior to Step S1. If the wheel is in detect, then the process moves to Step S3 to determine the nature of the wheel detect.

The wheel detect may be determined to be either a scroll, i.e. an angular input, or a touch, i.e. a button press on one of the virtual buttons.

To be determined as a touch, it is required that there is a succession of at least m detects of angles Θᵢ that lie within one of the pre-assigned angular ranges for the virtual touch buttons, i.e.,
Θ1<Θᵢ<Θ2 for at least m detects,
Θ3<Θᵢ<Θ4 for at least m detects,
Θ5<Θᵢ<Θ6 for at least m detects, or
Θ7<Θᵢ<Θ8 for at least m detects

The minimum number of detects required is preferably at least 3, more preferably between 3 and 10 inclusively.

To be determined as a scroll, it is required that there is a succession of at least k detects of successively increasing or successively decreasing angle □which span over at least a threshold angle. The threshold angle is thus an angle that must be scrolled round before a scroll is detected. For a finger actuated sensor, this is preferably set to somewhere between about 10 degrees and 90 degrees, most preferably between about 30 and 60 degrees, in particular between 40 and 50 degrees. The output is the total angular range over which the sequence of successively increasing, or successively decreasing, reported angles extend. The minimum number of detects k for scrolling may conveniently be equal to the minimum number of detects m for a virtual touch. The number k is also preferably set having regard to the angular resolution of the sensing path so that it implies a minimum angular displacement.

If a touch on a virtual button or a scroll is determined then the valid result flag is set.

In Step S4, if a valid result has occurred in the center button or the wheel, then the process proceeds to Step S5 and a signal is output on one of pins 9 and 10 of the microcontroller, i.e. to one of lines 122 and 124. If a scroll has been detected, then the angular range δΘ of the scroll is output on line 122. If a touch has been detected, then this is output on line 124 with an indication of whether the touch is on the “real” center button 108 or on one of the “virtual” buttons 110 to 113. In an alternative implementation, the outputs are provided on a single pin. The process flow then loops back to the start prior to Step S1 and repeats endlessly until interrupted by a suitable command.

It will be appreciated that the example process flow of FIG. 5 is one of many possible options. For example, wheel and center button signals may be processed in parallel. Moreover, adjacent key suppression may be used between the center button and the wheel signals, for example as described in my earlier U.S. Pat. No. 6,993, 607 and U.S. Ser. No. 11/279,402. Further it will be understood that in an alternative embodiment the center button could be dispensed with.

It will also be appreciated that although the above description relates to a wheel with virtual buttons, the conductive sensing path need not be circular. For example a linear path may be used, i.e. a so-called slider. The operation would be analogous to an annular path device, it being understood that references to angular displacements and so forth in the above example would be replaced with linear displacements. A linear path device may be advantageous for controls of domestic appliances such as microwave ovens and cooker tops (i.e. hobs). Other shapes of sensing path are also possible, for example as described in WO2005/019766A2, specifically in FIGS. 14A and 14C thereof. A linear sensing path may also be preferred for some computer-related device applications for scrolling through office applications, for example a vertically extending slider along one side of a display area, or contiguous with the display area.

Furthermore, finger actuation is not the only possible implementation. A knob actuation where the knob has a capacitive actuator such as a wiper may be used, as described in WO2005/019766A2, specifically with reference to FIGS. 11A and 11B, or FIG. 12 thereof. This may provide for greater resolution along the sensing path.

Furthermore, it will be understood that a resistive sensing path may be used instead of a conductive sensing path, as described in WO2005/019766A2, specifically with reference to FIGS. 3 to 8 thereof. A resistive sensing path can be made of any resistive material including carbon film, metal films, ITO or SnO, conductive plastics, screen deposited conductors, sputtered conductors etc. without limitation as to material or method of deposition.

The above example shows four virtual buttons distributed at equal angular separations along the sensing path. It will be appreciated that the virtual button placement along the sensing path is arbitrary, and may be dynamically altered in a single device if desired. Moreover, the number of virtual buttons may be arbitrarily selected with any number from one to the maximum possible according to resolution constraints being possible. This is true regardless of the shape of the sensing path, i.e. annular, linear etc.

The above example shows three electrodes making up the sensing path. The number of electrodes can be varied as desired. Three is the minimum for a closed loop. Two is the minimum for a non-closed path. Typical numbers of such electrodes will be in the range three to five.

It will further be appreciated that the above-mentioned bursting to a threshold defined by a comparator is only one mode of signal collection. Other charge transfer sequences could also be used. For example, in other schemes, a similar switching sequence to that described above could be executed a fixed number of times (rather than a variable number of times based on whether a reference threshold voltage is exceeded). After the fixed number of times, the voltage on each sampling capacitor can be measured using an analogue to digital converter and said voltages used to determine the position of a touch in a manner analogous to that described above (remembering however that said voltages would be directly related to how much charge is transferred during each transfer cycle and not inversely related as with burst mode). Burst mode operation, however, has the advantage that it can be implemented with comparators and counters, rather than more complex analogue to digital converters.

It will also be appreciated that the method of switching described herein can be adapted to any of the switching sequences and topologies as described in my U.S. Pat. No. 6,466,036 and these are incorporated herein by reference.

Further, it will be appreciated that the touch panel preferably has a sleep mode for power saving in which the touch surface is polled over longer time intervals. The sleep mode will activate automatically after a certain duration of no inputs.

There are many variations possible as will become evident to those skilled in the art, involving various combinations of detection methods or switch sequences outlined specifically herein. The method can be combined with methods taught in any number of the inventor's prior patents including methods for drift compensation, calibration, moisture suppression using short switch closure times, noise immunity via variable timing pulse modulation (spread spectrum), and the like.

Although it is believed that the foregoing rather broad summary description may be of use to one who is skilled in the art and who wishes to learn how to practice the invention, it will be recognized that the foregoing recital is not intended to list all of the features and advantages.

Although the present invention has been described with respect to preferred embodiments, many modifications and alterations can be made without departing from the invention. Accordingly, it is intended that all such modifications and alterations be considered as within the spirit and scope of the invention.

What is claimed is:

1. A capacitive position sensor for detecting a position of an object comprising:
(a) a sensing element comprising a sensing path, the sensing path having one or more designated sensing areas along its length;
(b) a plurality of terminals connected to the sensing element at different locations along the sensing path to subdivide it into a plurality of sections;
(c) a plurality of sensing channels connected to respective ones of the terminals, wherein each sensing channel is operable to generate a signal indicative of capacitance between its terminal and a system ground; and
(d) a processor operable to determine over which section the object is positioned by comparing the signals from the sensing channels, and to determine the position of the object within that section by comparing at least the signals from the terminals spanning that section, wherein the processor is operable to distinguish between a button touch in an absolute position on one of the plurality of sensing areas and a scroll touch caused by a moving displacement along the sensing path, respectively based on duration of touch and distance of displacement along the sensing path.

2. A capacitive position sensor according to claim 1, wherein the sensing path forms a closed loop.

3. A capacitive position sensor according to claim 2, wherein the closed loop is circular, thereby forming an annular sensing path.

4. A capacitive position sensor according to claim 3, comprising a further capacitive sensing element arranged within the annular sensing path.

5. A capacitive position sensor according to claim 1, wherein the sensing path is linear.

6. A capacitive position sensor according to claim 1, wherein the sensing path comprises a plurality of at least three tapering electrodes of conductive material extending adjacent to each other with a gap therebetween and connected to respective ones of the terminals.

7. A capacitive position sensor according to claim 1, wherein the processor is operable to repeatedly determine position of the object to collect a succession of position signals, and: (i) to determine a scroll touch if the succession of position signals specify positions that extend over at least a threshold distance, and in response thereto provide a motion output signal indicative of the distance through which the object has moved along the sensing path; and (ii) to determine a button touch if the succession of position signals specify positions that lie in one of the plurality of sensing areas, and in response thereto provide a position output signal indicative of the sensing area that has been actuated.

8. A capacitive position sensor according to claim 1, wherein there are at least three terminals connected to the sensing element at different locations along the sensing path to subdivide it into at least three sections.

9. A capacitive position sensor according to claim 1, wherein there are a plurality of designated sensing areas spaced along the sensing element.

10. A device incorporating a capacitive position sensor according to claim 1.

11. A method of detecting the position of an object comprising:
(a) providing a capacitive position sensor comprising a sensing element comprising a sensing path, a plurality of terminals connected to the sensing element at different locations along the sensing path to subdivide it into a plurality of sections, and a plurality of sensing channels connected to respective ones of the terminals;
(b) designating at least one sensing area on the sensing path;
(c) bringing the object into proximity with the sensor;
(d) generating a signal with each sensing channel indicative of capacitance between its terminal and a system ground;
(e) processing the signal to determine over which section the object is positioned by comparing the signals from the sensing channels, and to determine the position of the object within that section by comparing at least the signals from the terminals spanning that section, wherein a button touch in an absolute position on one of the plurality of sensing areas and a scroll touch caused by a moving displacement along the sensing path is determined based on duration of touch and distance of displacement along the sensing path respectively; and
(f) respectively outputting a position output signal or a motion output signal when a button touch or a scroll touch has been determined.
